(19) United States
(12) Patent Application Publication
(10) Pub. No.: US 2017/0329836 A1
(43) Pub. Date: Nov. 16, 2017

(54) DATABASE TRANSFER OF CHANGES

(71) Applicant: Hewlett Packard Enterprise Development LP, Houston, TX (US)

(72) Inventors: Alkis Simitsis, Santa Clara, CA (US); William K. Wilkinson, San Mateo, CA (US); Vaibhav Arora, Palo Alto, CA (US)

(21) Appl. No.: 15/529,423

(22) PCT Filed: Nov. 26, 2014
(86) PCT No.: PCT/US2014/067599

§ 371 Date: May 24, 2017

(51) Int. Cl. G06F 17/30

(52) U.S. Cl. CPC G06F 17/30592; G06F 17/30221; G06F 17/30451

(57) ABSTRACT

Example implementations relate to a database transfer of changes. For example, a computing device may include at least one processor. The at least one processor may receive a stream of changes to an online transaction processing (OLTP) database and may cache the stream of changes in a buffer. The at least one processor may identify specified criteria indicating a manner of sending the stream of changes to an online analytical processing (OLAP) database and may transfer the stream of changes from the buffer to the OLAP database based on the specified criteria.

### BACKGROUND

Many entities (e.g., enterprises, organizations, computer applications, etc.) utilize databases for storage of data relating to the entities. The data in a database may be received from a data stream of incoming data. Data stored in these databases may be accessed and analyzed for various purposes.

### BRIEF DESCRIPTION OF THE DRAWINGS

Some examples of the present application are described with respect to the following figures:

FIG. 1 is a block diagram of an example hybrid database management system for transferring changes to an online analytical processing database;

FIG. 2 is a block diagram of a computing device for transferring changes to an online analytical processing database; and

FIG. 3 is a flowchart illustrating an example method of transferring changes to an online analytical processing database.

### DETAILED DESCRIPTION

As described above, data stored in a database may be accessed and analyzed for various purposes. A database management system (DBMS) may manage and control access to a particular database in response to queries for data. Typically, a DBMS may be optimized for a particular type of workload, such as online transaction processing (OLTP) or online analytical processing (OLAP). OLTP pertains to a class of information systems that may facilitate and manage transaction-oriented applications, such as data entry and retrieval transaction processing. OLAP is an approach to answering multi-dimensional analytical queries, such as business reporting. OLTP requests may be relatively short and may read or write only a few database records, while OLAP requests may be relatively long, may access a large number of records, and may allow primarily read-only access. As such, OLAP requests sent to an OLTP-optimized DBMS and/or OLTP requests sent to an OLAP-optimized DBMS may generally perform poorly.

A hybrid DBMS having a synchronization engine may be utilized to optimize access to and/or modification of both an OLTP database and an OLAP database, providing a unified framework capable of handling both OLTP and OLAP workloads concurrently. In some examples, the features of the hybrid DBMS may be implemented as a module on top of existing OLTP and OLAP DBMSs. The OLTP and OLAP databases contain at least some common data, but the common data in each database may be stored in different representations, where the common data in the OLTP database may be the current version of the common data while the common data in the OLAP database may be either the current version or a previous version of the common data. The synchronization engine of the hybrid DBMS may manage the synchronization of modifications from the OLTP database to the OLAP database to ensure that modifications to the OLTP database are propagated to the OLAP database and may provide access to data that is in-transit between the OLTP database and the OLAP database. An interface module of the hybrid DBMS may be used to interface the hybrid DBMS with one or more applications such that the hybrid DBMS may appear to the applications as a single DBMS. In some examples, the hybrid DBMS is not a federated system, and the interface module may control access and/or updates to the OLTP and the OLAP database engines of the hybrid DBMS. As such, any applications accessing and/or updating the OLTP and OLAP databases through the interface module do not directly access the OLTP and the OLAP database engines.

The synchronization engine of the hybrid DBMS may receive a stream of committed changes to the OLTP database and may cache the stream of changes in a local buffer. The synchronization engine may load the buffered changes into the OLAP database according to specified criteria indicating a manner of sending the buffered changes to the OLAP database. The specified criteria may be default criteria and/or user-specified criteria that may indicate application-specified objectives (e.g., freshness of data, throughput, periodic transfer of data, etc.) relating to a manner of sending buffered changes to the OLAP database. Loading of buffered changes may be transactionally consistent such that when a set of transactions is committed by the OLTP database engine, the entire set of committed transactions is sent to the OLAP database engine for storage in the OLAP database. The synchronization engine may provide query access over the buffer such that applications may be able to query the freshest data.

The hybrid DBMS may direct OLTP transactions to the OLTP DBMS and may direct OLAP transactions to the OLAP DBMS, which may provide efficient performance because each request received may be sent to the DBMS that is optimized to process it. Modifications (e.g., updates, deletions, insertions), even those within an OLAP transaction, may be directed to the OLTP DBMS. These modifications are propagated from the OLTP DBMS to the OLAP DBMS in a manner that preserves database consistency and keeps pace with the OLTP DBMS. Additionally, transaction isolation is ensured despite transactions that span multiple DBMSs. Techniques to ensure consistency and isolation are described in further detail below. While the examples disclosed herein describe a hybrid architecture of a single OLTP database engine and a single OLAP database engine, one of ordinary skill in the art will appreciate that the techniques disclosed herein may be used with multiple independent OLTP database engines and a single OLAP database engine. For example, to increase transaction throughput, an OLTP database may be partitioned across multiple independent OLTP database engines where each OLTP transaction may access a single partition. The hybrid DBMS described herein may support this partitioning for multiple independent OLTP database engines. For example, an update transaction at a particular OLTP database engine may access a single OLTP database partition as well as the OLAP database, while a read-only transaction may access any partition as well as the OLAP database.

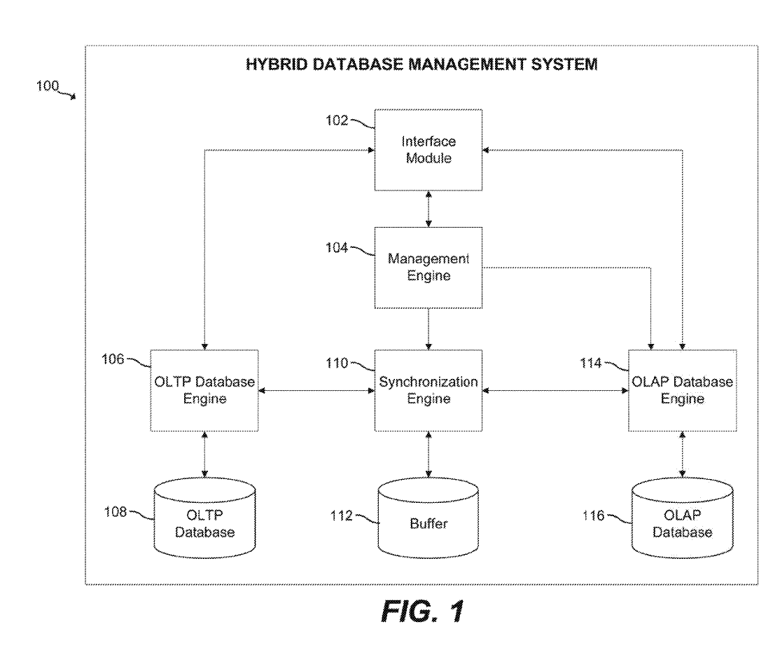

Referring now to the figures. FIG. 1 is a block diagram of an example hybrid DBMS 100 for transferring changes to an OLAP database. The components of hybrid DBMS 100 may operate using one or more processors (not shown) to perform the functions of the components.

Interface module 102 is a hardware-implemented and/or processor-implemented module that provides one or more unified application programming interfaces (APIs) to any applications to allow communication between the applications and hybrid DBMS 100. Interface module 102 may maintain session and transaction context, accept requests for data, forward those requests to the appropriate DBMS (e.g., OLTP database engine 106 or OLAP database engine 114) for processing, and return results in response to the requests.

OLTP database engine 106 is a hardware-implemented and/or processor-implemented module that manages and controls writing data to OLTP database 108, reading data from OLTP database 108, and processing OLTP requests. OLTP database 108 may be any suitable database optimized for OLTP. While examples disclosed herein describe an OLTP database engine and an OLTP database, one of ordinary skill in the art will recognize that any suitable write-optimized database engine and write-optimized database may be used with the techniques described herein.

OLAP database engine 114 is a hardware-implemented and/or processor-implemented module that manages and controls writing data to OLAP database 116, reading data from OLAP database 116, and processing OLAP requests. OLAP database 116 may be any suitable database optimized for OLAP. While examples disclosed herein describe an OLAP database engine and an OLAP database, one of ordinary skill in the art will recognize that any suitable read-optimized database engine and read-optimized database may be used with the techniques described herein.

Synchronization engine 110 is a hardware-implemented and/or processor-implemented module that may manage and control the synchronization of data between OLTP database engine 106 and OLAP database engine 114. For example, synchronization engine 110 may collect changes to table rows in OLTP database 108 from OLTP database engine 106, cache the changes locally in buffer 112, and load the changes to the OLAP database engine 114 for storage in OLAP database 116 at the appropriate time and/or in the appropriate manner based on specified criteria. Buffer 112 may be any suitable storage device capable of storing changes from OLTP database engine 106. Synchronization engine 110 may provide query capability over in-transit data that may be stored in buffer 112 but not yet loaded to OLAP database engine 114. Synchronization engine 110 may also validate transactions.

Management engine 104 is a hardware-implemented and/or processor-implemented module that provides various management functions, such as managing criteria specifying a manner of sending changes from buffer 112 to OLAP database engine 114 for storage in OLAP database 116, determining when and/or how to initiate transfer of changes from buffer 112 to OLAP database engine 114 for storage in OLAP database 116, managing garbage collection of old data, and the like. For example, management engine 104 may manage criteria that specifies a particular time delay for collecting garbage (e.g., collect every 5 seconds, collect when fresh data is requested by a query, etc.). Garbage collection refers to a processing of collecting data that may no longer be requested by any query (e.g., old versions of data that has since been updated).

As described earlier, while read requests may be sent to either OLTP database engine 106 or OLAP database engine 114, data modification requests (e.g., insert, delete, and/or update operations) are directed to OLTP database engine 106. In either case, hybrid DBMS 100 provides each request with a consistent view of the databases associated with hybrid DBMS 100 to ensure that each transaction sees a consistent view of the data. If the transaction is a single request, consistency is ensured because the request may be entirely processed by one engine. For example, assuming each transaction executes entirely on OLTP database engine 106 or entirely on OLAP database engine 114, OLTP database engine 106 may perform local concurrency control using any scheme it chooses, resulting in transactions that are isolated and serializable such that transactions appear to execute sequentially and one at a time. In this case, when a transaction is ready to commit, OLTP database engine 106 may send a transaction validation request to synchronization engine 110 and may include the transaction start time and an identification of the rows modified during the transaction. As such, synchronization engine 110 may be able to immediately acknowledge the commit to OLTP database engine 106, and no validation may be required since there may be no conflicting transactions.

Read-only queries that execute only on OLAP database engine 114 may also be provided a consistent view of OLTP database 108 and OLAP database 116 because, as described earlier, data changes from OLTP database engine 106 are applied to OLAP database engine 114 as logically atomic, transactionally consistent operations. If a transaction includes multiple requests, consistency may be ensured. For example, assuming that multi-request transactions are delimited by begin and commit requests, the begin request may identify the database engine that may handle the transaction (e.g., OLTP database engine 106 for transactions that modify data, either OLTP database engine 106 or OLAP database engine 114 for read-only transactions, etc.). When an OLAP multi-statement transaction statement begins, if the transaction requests the freshest data, the transaction waits until synchronization engine 110 sends the latest batch of buffered updates. Otherwise, the transaction may begin without waiting. OLAP database engine 114 then guarantees the transaction a consistent view of the data for all its statements until it commits. For example, the view may be read-committed, serializable, and the like, depending on application requirements. For a multi-statement OLTP transaction (e.g., a read-only query sent to OLAP database engine 114 to compute some aggregate value over a set of data objects), OLTP database engine 106 may not see the read-only query sent to OLAP database engine 114, so the OLTP database engine 106 may not, by itself, ensure the transaction sees a consistent view of data it accessed. To address this, synchronization engine 110 may perform a validation operation as part of the transaction commit operation to ensure that the data read by the OLAP query has not been updated. Validation may be performed is several ways, as described below.

The row-level data modifications of a transaction may be cached in buffer 112 by synchronization engine 110. Additionally, views may be installed on OLAP database engine 114 that enable this cached data to be queried on-demand to obtain the most recent data. For example, if an application submits an OLAP query that requests fresh data (e.g., the most recent data), OLAP database engine 114 may utilize synchronization engine 110 to read the cached data in buffer 112. While this may not provide an application with a consistent view of data, it may be made available as an application option. Periodically (or at any other time indicated by the specified criteria), management engine 104 may signal synchronization engine 110 to forward a consistent set of cached updates to OLAP database engine 114. At this time, synchronization engine 110 may merge the cached modifications into a single batch update transaction that may be sent to OLAP database engine 114 to synchronize the data in OLAP database 116 with data in OLTP database 108. OLAP database engine 114 may process and commit this batch update before the arrival of the next batch update from synchronization engine 110 without interference with concurrent analytic queries on OLAP database engine 114. Once OLAP database engine 114 has acknowledged the batch update, the cached data that was transferred may be purged from buffer 112. As such, when a query of OLAP database engine 114 requests fresh data. OLAP database engine 114 may request changes from synchronization engine 110, and synchronization engine 110 may send the requested changes to OLAP database engine 114. The query may then be processed using OLAP database engine 114.

In some examples, a split transaction may be processed on hybrid DBMS 100. A split transaction may be a multi-statement transaction in which some statements execute on OLTP database engine 106 and some statements execute on OLAP database engine 114. For example, an OLTP transaction may request aggregate values computed over a large amount of historical data in order to determine how to modify the database. Such a query may be more efficiently processed by OLAP database engine 114 rather than OLTP database engine 106, and a split transaction may be generated. Because OLTP database engine 106 is unaware of any statements processed by OLAP database engine 114, read-write conflicts between changes on OLTP database engine 106 and queries on OLAP database engine 114 may be missed. To detect these conflicts, synchronization engine 110 may perform a validation operation. Table 1 below summarizes examples of possible conflicts, where Xactᵥₐₗ refers to a transaction to be validated and Xact_{cmt} refers to another transaction that has committed during the lifetime of Xactᵥₐₗ. A read operation of row X is denoted as Rd X, and a write operation of row X is denoted Wt X. To maintain database consistency, if a first transaction commits before a second transaction, then any database changes made by the first transaction are visible to the second transaction.

TABLE 1
Examples of Validating Transactions

| Case No. | Xact_{cmt} | Xactᵥₐₗ |
|---|---|---|
| 1 | Rd X | Rd X |
| 2 | Rd X | Wt X |
| 3 | Wt X | Rd X |
| 4 | Wt X | Wt X |

In example case number 1 in Table 1 above, the read operation of Xact_{cmt} does not conflict with the read operation of Xactᵥₐₗ because committing a read of row X during Xactᵥₐₗ does not conflict with performing a read of row X. As such. Xactᵥₐₗ is successfully validated.

Similarly, in example case number 2 in Table 1 above, the read operation of Xact_{cmt} does not conflict with the write operation of Xactᵥₐₗ because committing a read of row X during Xactᵥₐₗ does not conflict with performing a write of row X. As such, Xactᵥₐₗ is successfully validated.

In example case number 4 in Table 1 above, the write operation of Xact_{cmt} and Xactᵥₐₗ may be detected and handled by OLTP database engine 106, and as such. Xactᵥₐₗ is successfully validated.

In example case number 3 In Table 1 above, a possible conflict may arise depending on which version of X was read by Xactᵥₐₗ. If Xactᵥₐₗ read the row X version written by Xact_{cmt}, there is no conflict, and Xactᵥₐₗ may commit. If Xactᵥₐₗ read the row X version prior to the Xact_{cmt} write operation, then the transactions are not serializable, and Xactᵥₐₗ cannot commit. To detect this conflict, a validation operation may be performed in any suitable manner. For example, it may be possible to compute and retain a content-based hash of the values read. Then, at validation, the read operation may be repeated, and a content-based hash of that result may be determined. This hash may be compared with the previously hashed value. If the values are the same, Xactᵥₐₗ is successfully validated. If the values are different, validation fails.

Management engine 104 may manage the task of computing and retaining the content-based hash result of split-transaction statements sent to OLAP database engine 114. At validation time, these statements and their hashes are sent from management engine 104 to synchronization engine 110 for validation by synchronization engine 110. For example, in example case number 3 in Table 1 above, a content-based hash may be computed on the value of X read by Xactᵥₐₗ and retained by management engine 104. At validation time, management engine 104 may send this content-based hash to synchronization engine 110 along with the corresponding query that read row X. To validate that the read result has not changed, synchronization engine 110 executes this query again and computes the hash on the current result set. If the has value matches that of the initial read query, validation is successful and Xactᵥₐₗ may commit. The read operation for validation may read data committed while Xactᵥₐₗ was executing. To do this, OLAP database engine 114 may read from synchronization engine 110 any committed updates that have not yet been sent to OLAP database engine 114. While a particular validation operation is described herein, one of ordinary skill in the art will appreciate that other validation techniques may be used. For example, the validation operation may include comparing read and write sets.

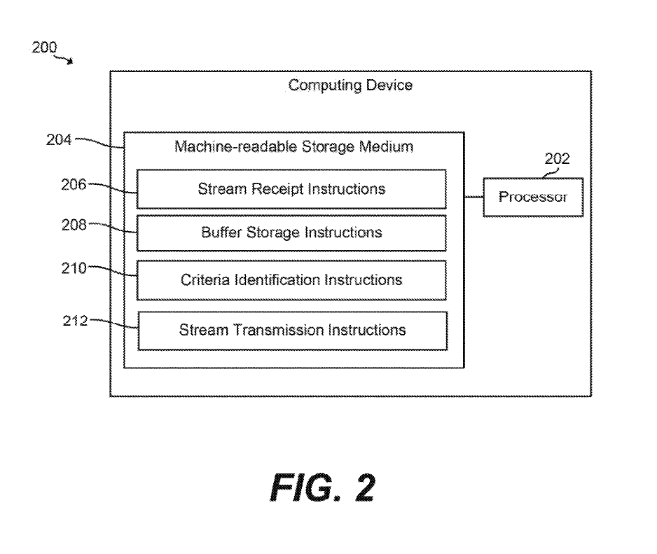

FIG. 2 is a block diagram of an example computing device 200 for transferring changes to an OLAP database. In some examples, computing device 200 may be a synchronization engine, such as synchronization engine 110 of FIG. 1.

Computing device 200 may be, for example, a web-based server, a local area network server, a cloud-based server, a notebook computer, a desktop computer, an al-in-one system, a tablet computing device, a mobile phone, an electronic book reader, a printing device, or any other electronic device suitable for transferring changes to an OLAP database. Computing device 200 may include a processor 202 and a machine-readable storage medium 204. Computing device 200 may store a stream of changes to an OLTP database in a buffer and may transmit the stream of changes from the buffer to an OLAP database based on criteria specifying a manner of sending the stream of changes to the OLAP database.

Processor 202 is a tangible hardware component that may be a central processing unit (CPU), a semiconductor-based microprocessor, and/or other hardware devices suitable for retrieval and execution of instructions stored in machine-readable storage medium 204. Processor 202 may fetch, decode, and execute instructions 206, 208, 210, and 212 to control a process of transferring changes to an OLAP database. As an alternative or in addition to retrieving and executing instructions, processor 202 may include at least one electronic circuit that includes electronic components for performing the functionality of instructions 206, 208, 210, 212, or a combination thereof.

Machine-readable storage medium 204 may be any electronic, magnetic, optical, or other physical storage device that contains or stores executable instructions. Thus, machine-readable storage medium 204 may be, for example, Random Access Memory (RAM), an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with a series of processor executable instructions 206, 208, 210, and 212 for receiving a stream of changes to an OLTP database, storing the stream of changes in a buffer, identifying specified criteria indicating a manner of sending the stream of changes to an OLAP database, and transmitting the stream of changes from the buffer to the OLAP database based on the specified criteria.

Stream receipt instructions 206 may manage and control receipt of a stream of changes. The stream of changes may be changes to be applied to an OLTP database. For examples, the stream of changes may include updates, insertions, and/or deletions associated with the OLTP database.

Buffer storage instructions 208 may manage and control the storing of the stream of changes in a buffer. For example, buffer storage instructions 208 may store the stream of changes in the buffer after the stream of changes has been received.

Criteria identification instructions 210 may manage and control the identification of specified criteria indicating a manner of sending the stream of changes to an OLAP database. The specified criteria may be any suitable criteria indicating the manner of sending the stream of changes to the OLAP database, such as how to send the stream of changes, when to send the stream of changes (e.g., periodically, based on availability, etc.), an amount and/or size to send to the OLAP database, and the like.

Stream transmission Instructions 212 may manage and control the transmission of the stream of changes from the buffer to the OLAP database. For example, stream transmission instructions 212 may manage and control the transmission of the stream of changes based on the specified criteria identified.

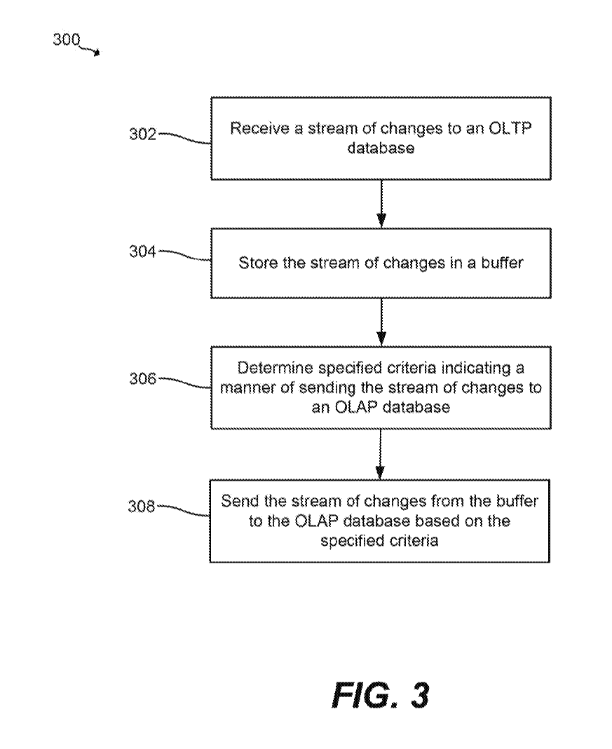

FIG. 3 is a flowchart illustrating an example method 300 of transferring changes to an OLAP database. Method 300 may be implemented using computing device 200 of FIG. 2.

Method 300 includes, at 302, receiving a stream of changes to an OLTP database. The stream of changes may include any changes to be applied to the OLTP database, such as updates, insertions, deletions, and the like.

Method 300 also includes, at 304, storing the stream of changes in a buffer. The stream of changes may be stored in the buffer after the stream of changes has been received.

Method 300 also includes, at 306, determining specified criteria indicating a manner of sending the stream of changes to an OLAP database. The specified criteria may be any suitable criteria indicating the manner of sending the stream of changes to the OLAP database, such as how and/or when to send the stream of changes, an amount and/or size to send to the OLAP database, and the like.

Method 300 also includes, at 308, sending the stream of changes from the buffer to the OLAP database based on the specified criteria. For example, if the specified criteria indicates that any changes in the buffer are to be sent to the OLAP after a particular amount of time has elapsed since the last data transfer, the stream of changes may be sent from the buffer to the OLAP database after that particular amount of time has elapsed.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Nun-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable Instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and the like.

What is claimed is:

1. A system comprising:
at least one processor to:
receive a stream of changes to an online transaction processing (OLTP) database;
cache the stream of changes in a buffer;
identify specified criteria indicating a manner of sending the stream of changes to an online analytical processing (OLAP) database; and
transfer the stream of changes from the buffer to the OLAP database based on the specified criteria.

2. The computing device of claim 1, wherein the specified criteria indicates periodically sending the stream of changes to the OLAP database.

3. The computing device of claim 1, wherein the stream of changes includes at least one of an update, an insertion, and a deletion.

4. The computing device of claim 1, wherein the at least one processor is further to:
receive a query of the OLAP database, the query requesting fresh data;
send the fresh data from the buffer to the OLAP database in response to the query; and
process the query using the OLAP database after the fresh data is sent to the OLAP database.

5. The computing device of claim 1, wherein the at least one processor is further to:
receive a query of the OLTP database, the query requesting historic data;
validate changes sent from the OLTP database to the OLAP database;
generate an OLTP sub-query and an OLAP sub-query relating to the query, the OLTP sub-query and the OLAP sub-query being generated based on the changes being validated; and
process the OLTP sub-query and an OLAP sub-query.

6. A method comprising:
receiving, by a computing device, a stream of changes to an online transaction processing (OLTP) database, the stream of changes including at least one of an update, an insertion, and a deletion with respect to an online analytical processing (OLAP) database;
storing, by the computing device, the stream of changes in a buffer;
determining, by the computing device, specified criteria indicating a manner of sending the stream of changes to the OLAP database; and
sending, by the computing device, the stream of changes from the buffer to the OLAP database based on the specified criteria.

7. The method of claim 6, wherein the specified criteria indicates periodically sending the stream of changes to the OLAP database.

8. The method of claim 6, wherein the specified criteria indicates sending the stream of changes to the OLAP database based on availability of the OLAP database.

9. The method of claim 6, further comprising:
receiving, by the computing device, a query of the OLAP database, the query requesting fresh data;
sending, by the computing device, the fresh data from the buffer to the OLAP database in response to the query; and
processing, by the computing device, the query using the OLAP database after the fresh data is sent to the OLAP database.

10. The method of claim 6, further comprising:
receiving, by the computing device, a query of the OLTP database, the query requesting historic data;
validating, by the computing device, changes sent from the OLTP database to the OLAP database;
generating, by the computing device, an OLTP sub-query and an OLAP sub-query relating to the query, the OLTP sub-query and the OLAP sub-query being generated based on the changes being validated; and
processing, by the computing device, the OLTP sub-query and an OLAP sub-query.

11. A non-transitory machine-readable storage medium storing instructions that, if executed by at least one processor of a computing device, cause the computing device to:
receive a stream of changes to an online transaction processing (OLTP) database;
store the stream of changes in a buffer;
identify specified criteria indicating a manner of sending the stream of changes to an online analytical processing (OLAP) database, the OLAP database having data previously stored in the OLTP database; and
transmit the stream of changes from the buffer to the OLAP database based on the specified criteria.

12. The non-transitory machine-readable storage medium of claim 11, wherein the specified criteria indicates periodically sending the stream of changes to the OLAP database.

13. The non-transitory machine-readable storage medium of claim 11, wherein the stream of changes includes at least one of an update, an insertion, and a deletion.

14. The non-transitory machine-readable storage medium of claim 11, wherein the instructions further cause the computing device to:
receive a query of the OLAP database, the query requesting fresh data;
send the fresh data from the buffer to the OLAP database in response to the query; and
process the query using the OLAP database after the fresh data is sent to the OLAP database.

15. The non-transitory machine-readable storage medium of claim 11, wherein the instructions further cause the computing device to:
receive a query of the OLTP database, the query requesting historic data;
validate changes sent from the OLTP database to the OLAP database;
generate an OLTP sub-query and an OLAP sub-query relating to the query, the OLTP sub-query and the OLAP sub-query being generated based on the changes being validated; and
process the OLTP sub-query and an OLAP sub-query.
